(19) United States
(12) Patent Application Publication
(10) Pub. No.: US 2022/0174976 A1
(43) Pub. Date: Jun. 9, 2022

(54) CONFECTIONERY MASS DOSING UNIT INCLUDING A LOCKING VALVE AND A DOSING VALVE

(71) Applicant: Sollich KG, Bad Salzuflen (DE)

(72) Inventors: Kersten Stolpe, Bad Salzuflen (DE); Thomas Ellinghoven, Herford (DE)

(21) Appl. No.: 17/527,755

(22) Filed: Nov. 16, 2021

(30) Foreign Application Priority Data
Dec. 7, 2020 (DE) 10 2020 132 509.6

(51) Int. Cl. A23G 1/04; A23G 1/00; A23G 1/20; A23G 3/34; A23G 3/02; A23G 3/20

(52) U.S. Cl. CPC A23G 1/045; A23G 1/0013; A23G 1/206; B65B 3/36; A23G 3/021; A23G 3/0257; A23G 3/203; A23G 3/0008

(57) ABSTRACT

An apparatus (1) for dosing a confectionery mass includes a plurality of confectionery mass dosing units (2) being arranged side-by-side. Each of the confectionery mass dosing units (2) includes a locking valve (18), a dosing valve (22) and an outlet opening (26). The outlet opening (26) serves to dispense a dosing quantity of confectionery mass from the confectionery mass dosing unit (2). The dosing valve (22) serves to adjust the dosing quantity. The locking valve (18) being an addition to the dosing valve (22) serves for alternate opening and closing, wherein no confectionery mass exits from the outlet opening (26) when the locking valve (18) is closed.

### CROSS REFERENCE TO RELATED APPLICATIONS

This application claims priority to co-pending German Patent Application No. DE 10 2020 132 509.6 filed Dec. 7, 2020.

### FIELD OF THE INVENTION

The present invention relates to a confectionery mass dosing unit and an apparatus for dosing a confectionery mass including a plurality of confectionery mass dosing units.

Confectionery mass dosing units serve to dispense a defined mass and a defined volume of a confectionery mass, respectively, in a clocked way from a confectionery mass reservoir during the production of confectioneries. The confectionery mass may be especially a mass containing fat and/or sugar and/or sugar substitutes. Examples are caramel, fondant, chocolate mass, fat glaze and the like. The dosed portion of the confectionery mass then especially is the finished confectionery product itself, a filling of the finished confectionery product or a coating of the finished confectionery product.

To allow for simultaneous dosing of a plurality of portions of confectionery mass, the apparatus includes a plurality of such confectionery mass dosing units. The apparatus may then especially be moved in a clocked way with respect to a conveyor belt to conduct dosing in an automatic production process.

### BACKGROUND OF THE INVENTION

An apparatus for dosing a confectionery mass including a plurality of confectionery mass dosing units being arranged side-by-side is known from international patent application WO 2016/010435 A1. The confectionery mass dosing units are supplied with confectionery mass via a common reservoir. Each confectionery mass dosing unit includes an outlet opening for dispensing a dosing quantity of confectionery mass from the confectionery mass dosing unit. The confectionery mass dosing units each include a dosing and locking valve being designed as a controllable squeeze valve. The dosing quantity and the point in time of discharge of the dosing quantity are determined by the squeeze valve.

Another apparatus for dosing a confectionery mass including a plurality of confectionery mass dosing units being arranged side-by-side is known from European patent application EP 2 941 962 A1 corresponding to U.S. patent application 2015/0313252 A1. The confectionery mass dosing units are supplied with confectionery mass from the common reservoir. Each confectionery mass dosing unit includes an outlet opening for dispensing a dosing quantity of confectionery mass from the confectionery mass dosing unit. The confectionery mass dosing units each include a dosing and locking valve being formed by the cooperation of a base body, a rotary piston, a closing element and an outlet nozzle. The dosing quantity and the point in time of discharge of the dosing quantity are determined by this valve. The rotary piston and the closing element are driven mechanically in a clocked way independently from one another.

An apparatus for producing three-dimensional objects of food mass is known from U.S. Pat. No. 6,280,784 B1. For example, the object may be an individually created birthday cake. According to FIG. 4, the apparatus includes two valve means being located downstream each of which includes a locking valve. Different masses—for example masses of different colors—can be dispensed by the two valve means.

### SUMMARY OF THE INVENTION

The present invention relates to a confectionery mass dosing unit including an outlet opening for dispensing a dosing quantity of confectionery mass from the confectionery mass dosing unit and a dosing valve for adjusting the dosing quantity. In addition to the dosing valve, the confectionery mass dosing unit includes a separate locking valve for alternate opening and closing. When the locking valve is closed, no confectionery mass exits from the outlet opening.

The present invention also relates to an apparatus for dosing a confectionery mass including a plurality of such confectionery mass dosing units being arranged side-by-side.

Such an apparatus includes a dosing beam. The confectionery mass dosing units are part of the dosing beam. The dosing beam (“manifold”) is arranged above a conveyor belt. The conveyor belt is driven to move in a sense of conveying direction. The dosing beam serves to apply the dosing quantity of confectionery mass by the confectionery mass dosing units onto the conveyor belt and the confectionery pieces being placed thereon, respectively, during a dosing cycle.

With the new confectionery mass dosing unit and the new apparatus including a plurality of such confectionery mass dosing units, it is possible to dispense a dosing quantity of confectionery mass in a clocked manner in a way that the dosing quantity can be adjusted exactly while the confectionery mass dosing unit has a long lifetime.

Usually, a multitude of confectionery pieces lies on the conveyor belt. The confectionery pieces are arranged in rows extending perpendicularly to the sense of conveying direction and in columns extending in the sense of conveying direction (and the conveying direction, respectively). A defined number of confectionery pieces is located in each properly formed row. This number coincides with the number of confectionery mass dosing units.

The dosing beam is moved vertically and horizontally by a drive including a motor. The upper part of the conveyor belt is continuously moved in the sense of conveying direction. During a dosing cycle, the dosing beam is commonly moved with the conveyor belt and thus the confectionery pieces such that the confectionery mass is dispensed onto the respective confectionery piece. However, it would also be possible that the conveyor belt is driven in a clocked manner and that the dosing beam is stationary.

The confectionery mass may be especially a mass containing fat and/or sugar and/or sugar substitutes. Examples are caramel, fondant, chocolate mass, fat glaze and the like. The dosed portion of the confectionery mass then especially is the finished confectionery product itself, a filling of the finished confectionery product or a coating of the finished confectionery product. The confectionery mass exists in the flowable form. It is also possible to adjust a differential velocity between the conveyor belt and the dosing beam such that the confectionery mass deposits in the form of a line.

A confectionery mass dosing unit for dispensing a defined dosing quantity in a clocked manner substantially includes the following two functions:

The first function (“primary function”) is opening and closing the outlet which is associated with dispensing and not dispensing, respectively, confectionery mass. Dispensing and not dispensing alternate in cycles. Thus, a dosing cycle and a locking cycle alternate. This is the main function which always occurs during normal operation of the confectionery mass dosing unit without malfunctions and errors. This primary function has to be fulfilled during efficient automatic operation of the confectionery mass dosing unit many times per time interval. It is possible that 100 or more dosing quantities per minute are dosed per confectionery mass dosing unit. Consequently, they have to be opened 100 times and closed 100 times. A correspondingly great load of the structural component fulfilling the primary function results from this often occurring primary function. In the above-described prior art document EP 2 941 962 A1 and U.S. 2015/0313252 A1, this primary function is realized by a squeeze valve. Such squeeze valves typically include elastomeric membranes being subjected to pressure for closing the squeeze valve. During a pressure subjection changing that often, there is the danger of the elastomeric membranes being ruptured after a comparatively short operational time. This results in undesired downtimes of the known apparatus.

The second function (“secondary function”) to be fulfilled is the adjustment of the dosing quantity. This is the quantity (and the volume, respectively) of confectionery mass being dispensed by a confectionery mass dosing unit during a dosing cycle.

The new confectionery mass dosing unit now separates the primary function and the secondary function structurally from one another and fulfills these with different and separate components. These are valves having different properties. Due to decoupling of the functions, the secondary function now has to be realized substantially less often as before. The secondary function only has to be realized when the conditions prevailing at the respective confectionery mass dosing unit have changed or there are other changes. The adjustment remains unchanged without such changes.

The locking valve may include a locking valve housing and the dosing valve may include a dosing valve housing. Thus, these are different housings.

The primary function is realized by a locking valve. The locking valve includes an opened position and a closed position. In the opened position, the dosing quantity of confectionery mass may exit from the outlet opening of the confectionery mass dosing unit. In the closed position of the locking valve, the confectionery mass is prevented from exiting from the outlet opening. The locking valve is designed such that it can realize the primary function, which is to be realized often, with low wear and tear and over a long lifetime.

The secondary function is realized by a dosing valve being arranged in the confectionery mass dosing unit in addition to and separate from the locking valve. This dosing valve can not only take a fully closed and a fully opened position, but also intermediate positions. The dosing quantity of confectionery mass can be adjusted by these intermediate positions. The dosing valve is designed such that it can realize the secondary function, which is to be realized rather rarely, in an exact and efficient way.

Such an apparatus including a plurality of such confectionery mass dosing units is also designated as a “manifold” by the person skilled in the art. With such apparatuses, for example, cookies or other pastries are filled with confectionery masses or covered with chocolate or a glazing. The confectionery pieces to be filled or to be covered are transported through the region of the apparatus side-by-side in a plurality of rows on a conveyor belt. The conveyor belt is especially continuously driven, while the apparatus is driven in a clocked manner. Anyway, the confectionery mass is not dispensed in a continuous way, but only temporarily. Dispensing especially occurs while the apparatus is temporarily moved commonly with a row of confectionery pieces. Afterwards, the apparatus returns to its starting position and follows the next row of confectionery pieces. However, it is also possible that the apparatus is not moved and that the conveyor belt is driven in a clocked manner. In this case, dosing occurs while the conveyor belt is not moving.

The dosing valve is a valve being subjected to pressure. The pressure subjection occurs by a pressure medium. The pressure medium may be a gas or a liquid. For example, the pressure medium is air, water or oil. Due to the pressure subjection, the flow rate of confectionery mass to be determined by the dose valve can be adjusted in an exact and quick manner. The flow rate is defined by a change of the free cross-sectional surface of the valve being available for passage of the confectionery mass. When the dosing valve is tendentially opened, this free cross-sectional surface is thus increased. When the dosing valve is tendentially closed, this free cross-sectional surface is decreased. By a change of the cross-sectional surface of approximately±3% to 30%, especially approximately±5% to 20%, especially approximately±10% to 15%, the desired and required adjustment of the dosing valve can often be realized.

When the pressure medium is air, the pressure usually prevailing at the dosing valve may be approximately 0.4 bar to 0.7 bar, especially approximately 0.5 bar. The variation of the pressure for adjusting the dosing valve then is approximately±0.3 bar, for example.

The dosing valve may be a hose squeeze valve. Such a hose squeeze valve is well suited to adjust the free cross-section of the dosing valve in a quick and exact manner by a variation of the pressure in the above-described way. Such a hose squeeze valve includes a housing in which a hose section being made of a resilient material is placed. There is a pressure chamber in the housing. The pressure chamber can be subjected to pressure. Depending on the pressure prevailing in the pressure chamber, the hose section is then squeezed more or less such that the free cross-section is decreased and increased, respectively.

The elastomeric membrane of the hose squeeze valve may be especially designed as a silicon injection molded part. However, other materials and manufacturing methods are also possible.

The dosing valve may be designed such that not only the dosing quantity, but also the geometry (shape) of the dosed confectionery mass is adjustable. In special cases, especially cases of errors, the dosing valve may also momentarily fulfill the primary function of the locking valve of the respective confectionery mass dosing unit.

The dosing valve may be designed to be continuously (steplessly) controllable. In this way, the desired variation of the free cross-section of the dosing valve and thus of the flow rate and the dosing quantity can be adjusted in an exact manner. However, it is also possible that this adjustment can be chosen in a stepped manner. Controlling the dosing valve means to control the opening size of the dosing valve. In other words, this is an adjustment of the throttling of the dosing valve.

The dosing valve may be designed to be manually or automatically controllable during operation of the confectionery mass dosing unit. Thus, for adjusting the dosing valve, the confectionery mass dosing unit and the apparatus including the confectionery mass dosing unit, respectively, does not have to be stopped and the production operation does not have to be interrupted. When the adjustment is realized by hand, the operator observes the dosing results and changes the dosing quantity of the respective dosing valve when there is a deviation of the dosing results from the set value (desired value). However, an automatic control is also possible.

The different adjustment of the dosing valves of the different confectionery mass dosing units in the common apparatus also results from them being arranged differently and thus different pressure conditions prevailing. These different pressure conditions are now compensated by different adjustments of the dosing valves in a way that a coincident dosing quantity of the separate dosing valves is realized despite these different conditions. However, it is also possible to consciously adjust different dosing quantities of the separate dosing valves and to thus produce different confectionery pieces in one row.

The locking valve may be a mechanically actuated valve. Due to this mechanical actuation, the locking valve is especially robust and have a long lifetime. This reflects the above-described separation of the primary function and the secondary function. The primary function is thus associated with the robust mechanically actuated locking valve and the secondary function is associated with the dosing valve which is subjected by pressure and which can be adjusted in an exact way.

The locking valve may be a rotary piston valve, a slide valve or a seat valve, for example, or any other suitable valve which at least has a fully opened position and a fully closed position. However, it is also possible that this valve has intermediate positions.

The locking valve may be opened and closed in cycles (clocked). As it has been explained above, this actuation in cycles serves to fulfill the portioning process in connection with the conveyed confectionery pieces which are to be filled or covered with the dosing quantity of confectionery mass.

The locking valves in the apparatus including a plurality of confectionery mass dosing units may be designed such that they can be commonly opened and closed. Such an actuation can be realized in a constructively simpler way, especially by mechanically coupling the locking valves with one another. Common actuation of the locking valves may be especially realized by a central actuator. The actuator may include a coupling rod or a valve shaft, for example.

However, it is also possible that the locking valves are designed such that they can be opened and closed independently.

During unobstructed and error-free operation of the apparatus, it is not necessary that confectionery mass only exits from a part of the outlet openings or that a dosing cycle is omitted. Each locking valve is associated with a confectionery piece in a row on the conveyor belt such that the dosing quantity is applied onto each confectionery piece in this row at the same time. However, something else may be true when a confectionery piece or a plurality of confectionery pieces are missing in a row. To ensure that no confectionery mass reaches the empty space on the conveyor belt where usually the confectionery piece should be located, it at least has to be prevented that confectionery mass exits from this outlet opening.

A first possibility during common actuation of the locking valves in such an error case is that a complete row is skipped, i.e. no confectionery mass is dispensed during a dosing cycle since the locking valves remain closed. This results in and error row which later has to be fully removed.

A second possibility during common actuation of the locking valves in such an error case is that the dosing valve being associated with the void is fully closed during the dosing cycle. This dosing valve then temporarily fulfills the primary function of the locking valve. The other dosing valves fulfill their secondary function in a totally normal way. One attains a row of confectionery pieces with only one void such that the row includes one confectionery piece less, but it can be fully used.

When the locking valves can be actuated independently from one another, in such an error case, only the locking valve being associated with the void in the row has to maintain closed. Thus, there is no complete row of confectionery pieces being provided with the dosing quantity of confectionery mass. However, all confectionery pieces existing in this row are proper and can be further processed.

For an automatic detection of errors, the apparatus may include an error detection apparatus being designed such that it issues an error signal when there is an error. This error may be especially a void (i.e. a completely missing confectionery piece), and incomplete or damaged confectionery piece or a confectionery piece not being located in its correct position. One of the above-described measures is taken when there is an error signal.

The dosing valves of the plurality of confectionery mass dosing units in the apparatus may be designed such that they can be controlled independently from one another. In this way, the dosing quantity of each dosing valve can be adjusted individually. This adjustment may be especially realized before starting the apparatus or during a product change. However, this adjustment is also possible during ongoing operation such that the apparatus does not have to be stopped.

The apparatus may include a control unit for adjusting the dosing valves of the confectionery mass dosing units. The control unit includes an operator interface (HMI; “Human Machine Interface”) via which the operator can make the necessary adjustments.

The control unit may be designed such that it considers that the dosing volume at a first confectionery mass dosing unit increases when an adjacent second confectionery mass dosing unit (or a plurality of adjacent confectionery mass dosing units) is not actuated—i.e. its locking valve or dosing valve is not opened. This is to be attributed to the lack of removal of confectionery mass by the second confectionery mass dosing unit from the common reservoir container for confectionery mass. The undesired increase of the dosing quantity at the first confectionery mass dosing unit is now counteracted by reducing the free cross-section of the dosing valve of the first confectionery mass dosing unit.

According to a variant a, the control unit and the dosing valves may be designed such that the dosing valves are controllable independently from one another. The locking valves of the confectionery mass dosing units are then designed such that they can be commonly opened and closed. The control unit is designed such that the dosing valve of a first confectionery mass dosing unit maintains closed when the locking valves are opened and the dosing valve the first confectionery mass dosing unit is opened and the dosing valve of an adjacent second confectionery mass dosing unit is closed.

According to a variant b, the control unit and the dosing valves may also be designed such that the dosing valves are controllable independently from one another. However, the locking valves of the confectionery mass dosing units are designed such that they can be opened and closed independently from one another. The control unit is designed such that the dosing valve of a first confectionery mass dosing unit is further closed when the locking valve of the first confectionery mass dosing unit is opened and the locking valve of an adjacent second confectionery mass dosing unit is closed.

During automatic control including a closed control loop, the dosing quantity of confectionery mass is especially determined on the basis of the diameter of a produced spot of confectionery mass. When this diameter is smaller than the set value, the respective dosing valve is further opened. When the diameter is greater than the desired diameter, the respective dosing valve is further closed.

The outlet opening for dispensing the dosing quantity of confectionery mass is arranged at the ending of the flow path of the confectionery mass through the confectionery mass dosing unit by definition. The dosing valve and the locking valve are each located upstream of the outlet opening. A first possible arrangement is that the dosing valve is located downstream of the locking valve and thus adjacent to the outlet opening. However, it is also possible that the locking valve is located downstream of the dosing valve and thus adjacent to the outlet opening. Furthermore, it is possible that additional valves and other components are arranged between the outlet opening, the dosing valve and the locking valve. However, the locking valve and the dosing valve are separate components.

The dosed volume of confectionery mass may be determined by an optical measurement method, for example. One example is a laser triangulation measurement. However, other measurement methods are also possible.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an outlet opening is mentioned, this is to be understood such that there is exactly one outlet opening or there are two outlet openings or more outlet openings. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with respect to preferred exemplary embodiments illustrated in the drawings.

FIG. 1 illustrates a perspective view of an exemplary embodiment of a new apparatus for dosing a confectionery mass including a plurality of confectionery mass dosing units as being used over a conveyor belt.

FIG. 2 illustrates a perspective view of a part of the apparatus of FIG. 1 from the front.

FIG. 3 illustrates a perspective view of the part of the apparatus of FIG. 1 from the rear.

FIG. 4 illustrates a view of the rear of the part of the apparatus according to FIG. 1.

FIG. 5 illustrates a longitudinal sectional view of the part of the apparatus according to FIG. 1.

FIG. 6 illustrates a cross-sectional view of the part of the apparatus according to FIG. 1.

FIG. 7 illustrates a perspective view of a second exemplary embodiment of the part of the new apparatus.

FIG. 8 illustrates a side view of the part of the apparatus according to FIG. 7.

FIG. 9 illustrates a longitudinal sectional view of the part of the apparatus according to FIG. 7.

FIG. 10 illustrates a cross-sectional view of the part of the apparatus according to FIG. 7.

### DETAILED DESCRIPTION

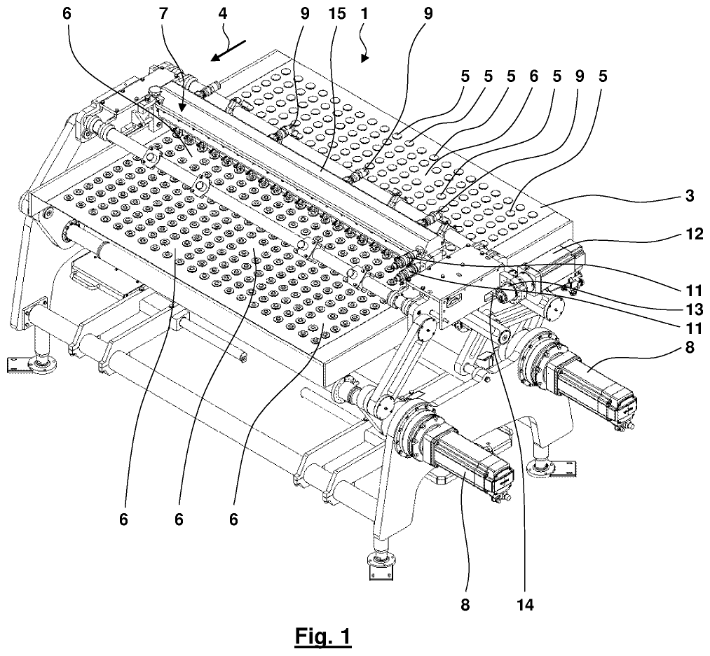

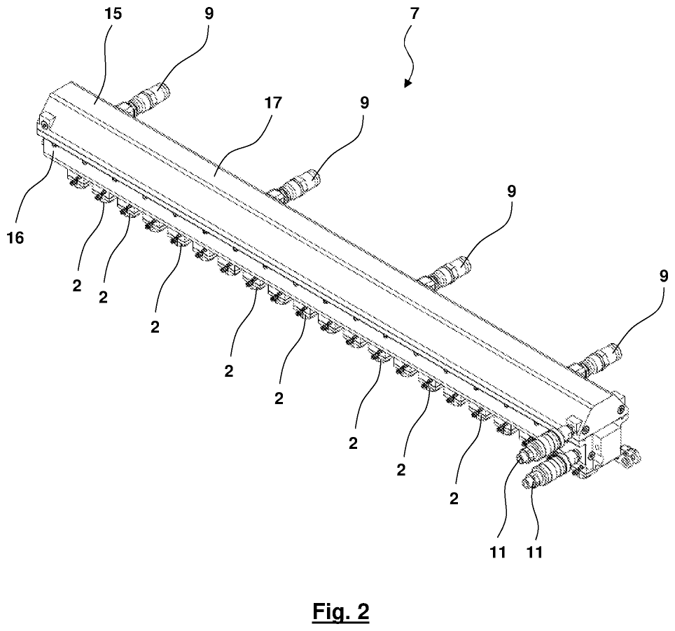

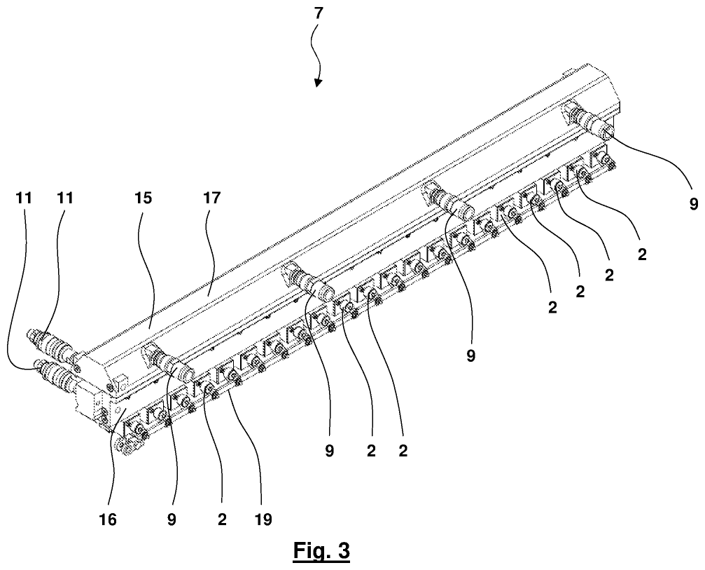

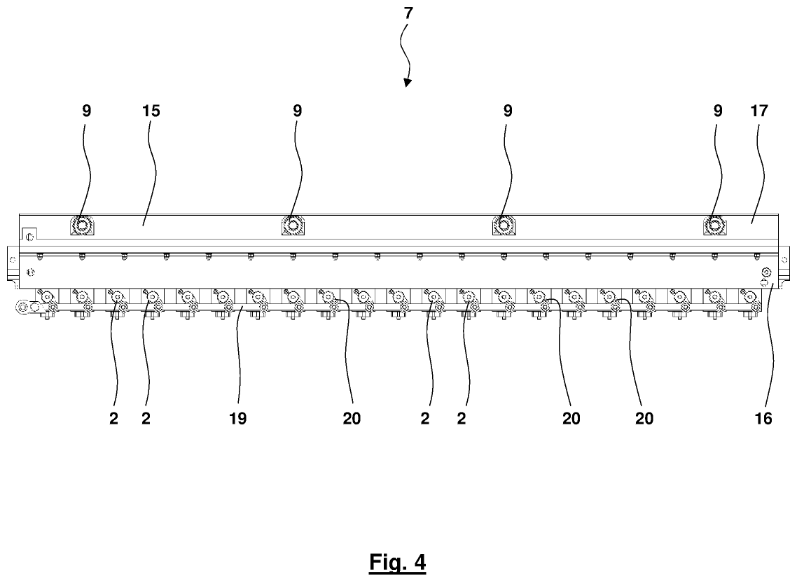

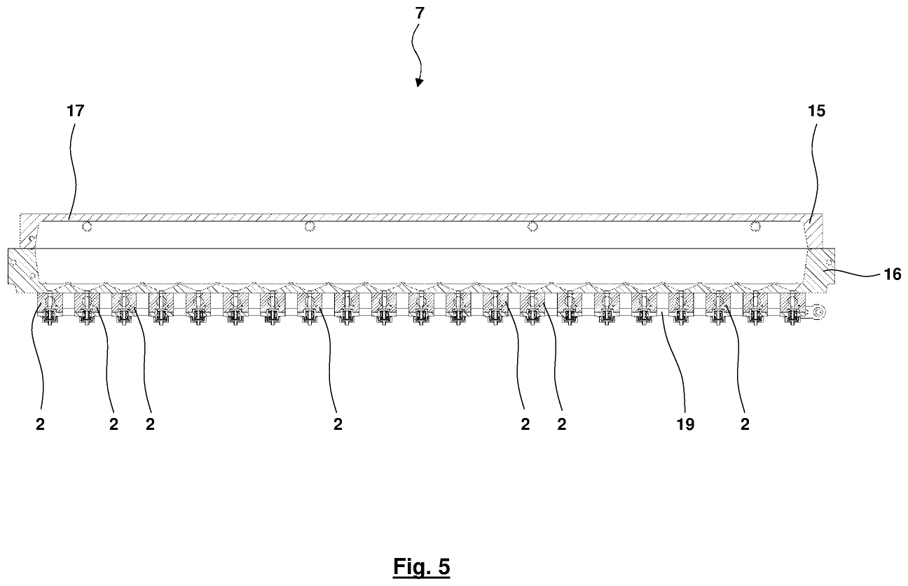

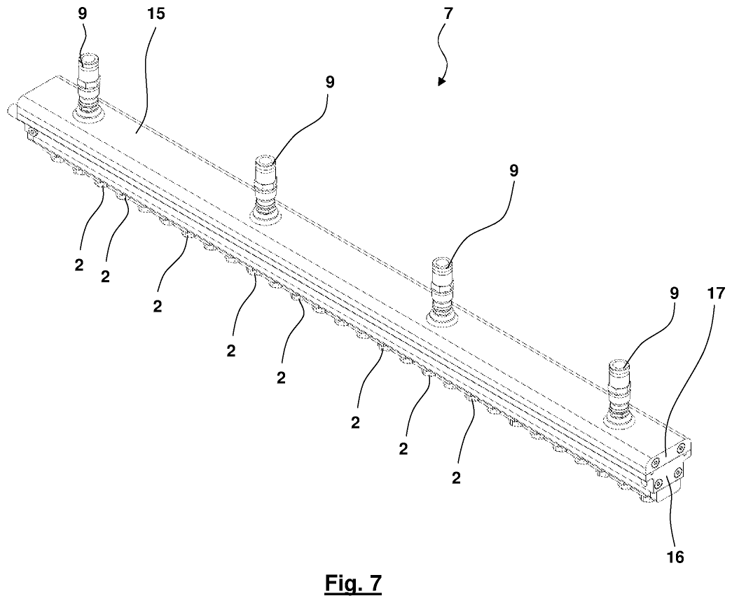

FIGS. 1 to 6 illustrate different views of parts of a first exemplary embodiment of the new apparatus 1 for dosing a confectionery mass including a plurality of confectionery mass dosing units 2. FIG. 1 illustrates a greater part of the apparatus 1, while FIGS. 2 to 5 illustrate details of the apparatus 1 and FIG. 7 illustrates a detail of a confectionery mass dosing unit 2.

The apparatus 1 includes a conveyor belt 3 being revolvingly driven in a sense of conveying direction 4. A multitude of confectionery pieces 5 rests on the upper part of the conveyor belt 3. The confectionery pieces 5 are located in rows extending perpendicularly to the sense of conveying direction 4 and in columns extending in the sense of conveying direction 4 (and the conveying direction, respectively). A defined number of confectionery pieces 5 is located in each properly formed row. It is to be seen in the present example that a confectionery piece 5 is missing in the third row as seen in the sense of conveying direction 4, among other things. This is a void 6. Additional voids 6 are illustrated for reasons of explanation. However, in practice usually only a small number of voids 6 exists.

The apparatus 1 includes a dosing beam 7 approximately in the middle region of the illustrated section of the conveyor belt 3 as seen in the sense of conveying direction 4. The dosing beam 7 serves to apply a flowable confectionery mass onto the confectionery pieces 5. This can be seen in FIG. 1 by the different illustrated designs of the confectionery pieces 5 upstream and downstream of the dosing beam 7.

The dosing beam 7 is moved vertically and horizontally by two electric motors 8. The conveyor belt 3 is continuously moved in the sense of conveying direction 4. The dosing beam 7 is moved along with the conveyor belt 3 and thus also with the confectionery pieces 5 during a dosing cycle such that the confectionery mass is dispensed onto the respective confectionery piece 5. This process taken in isolation is known from the prior art and will thus not be further described in the following. However, it would also be possible that the conveyor belt 3 is driven in a clocked manner and that the dosing beam 7 is stationary.

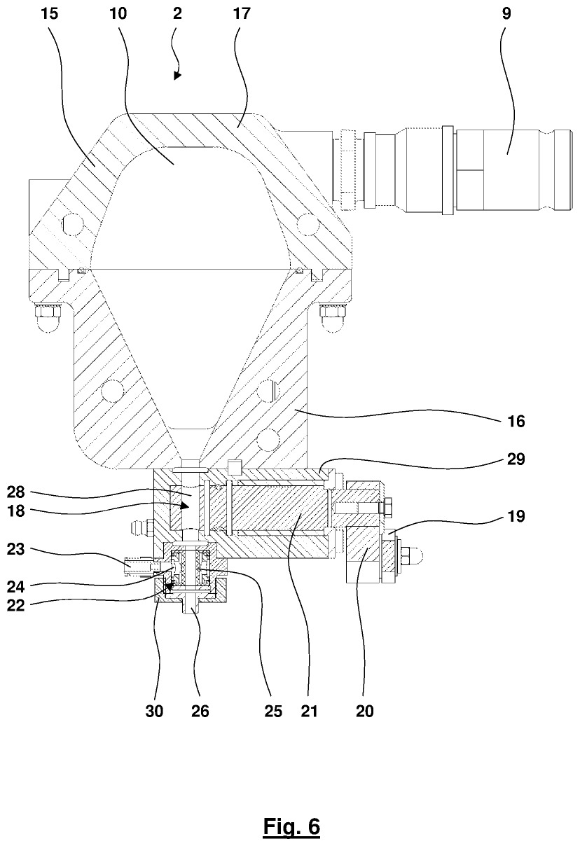

The dosing beam 7 includes a plurality of mass ports 9 through which the confectionery mass reaches a reservoir 10 (see FIG. 6). The dosing beam 7 furthermore includes water ports 11 over which water (or a different tempering medium) reaches the dosing beam 7 and exits from it, respectively. The desired temperature of the confectionery mass being contained in the reservoir 10 is obtained by the tempering medium.

It is also to be seen in FIG. 1 that the apparatus 1 includes a motor 12, especially a servo motor, a cam 13 and a push rod 14. These components serve to actuate the locking valves of the confectionery mass dosing units 2 which will be further explained below.

FIGS. 2 to 5 illustrate different views of the dosing beam 7 of FIG. 1. The dosing beam 7 includes a housing 15 at which the ports 9, 11 are arranged. Among other things, the reservoir 10 is formed in the housing 15.

Below the housing 15, the dosing beam 7 includes a plurality of confectionery mass dosing units 2. The number of confectionery mass dosing units 2 corresponds to the number of confectionery pieces 5 in a row on the conveyor belt 3. For reasons of clarity, only some of the confectionery mass dosing units 2 are designated with reference numerals in FIGS. 2 to 5. For the same reason, the components of the confectionery mass dosing units 2 are only designated with reference numerals in the detailed view of FIG. 6.

FIG. 6 illustrates an exemplary embodiment of the new confectionery mass dosing unit 2. The housing 15 includes a lower part 16 and a cover 17. The reservoir 10 is formed in the interior of the housing 15. Confectionery mass reaches the reservoir 10 via the mass support 9.

Downstream of the reservoir 10, the confectionery mass dosing unit 2 includes a locking valve 18 for alternate opening and closing. The locking valve 18 includes an (separate) locking valve housing 29. The locking valve 18 is a mechanically actuated valve. In the present example, it is a rotary piston valve. However, it could also be a different type of a locking valve 18.

The locking valve 18 is opened and closed in cycles (clocked). During the dosing cycle of the confectionery mass dosing unit 2 and of the apparatus 1, the locking valve 18 is opened. Otherwise, it is closed. In the present case, actuation of the locking valve 18 occurs together with all other locking valves 18 of the other confectionery mass dosing units 2 of the apparatus 1. Actuation occurs via a pushing movement of a coupling rod 19 being caused by the motor 12, the cam 13 and the pushing rod 14. Rotation of the coupling rod 19 is transferred onto a rotary piston 21 of the locking valve 18 via a coupling lever 20. A passage bore 28 is located in the rotary piston 21. Depending on the position of the rotary piston 21, the passage bore 28 is connected to the reservoir 10 or separated therefrom. In this way, the locking valve 18 takes its opened position and its closed position.

An additional and separate dosing valve 22 is arranged downstream of the locking valve 18. The dosing valve 22 includes its (own) dosing valve housing 30. The dosing valve 22 serves to adjust the dosing quantity of confectionery mass which is eventually applied to the confectionery pieces 5. The dosing valve 22 is a hose squeeze valve being subjected to pressure. The dosing valve 22 includes a port 23 via which a pressure medium, especially air or a liquid, reaches the interior of the dosing valve 22. There, a pressure chamber 24 is formed via which an adjustable pressure acts upon a hose section 25. Depending on the pressure level, the hose section 25 narrows or extends the free cross-section being available for passage of the confectionery mass. In this way, the dosing volume is controlled. FIG. 6 illustrates the dosing valve 22 in its pressureless condition in which the free cross-section is maximal.

An outlet opening 26 is arranged downstream of the dosing valve 22. The outlet opening 26 serves to dispense the dosing quantity of confectionery mass from the confectionery mass dosing unit 2.

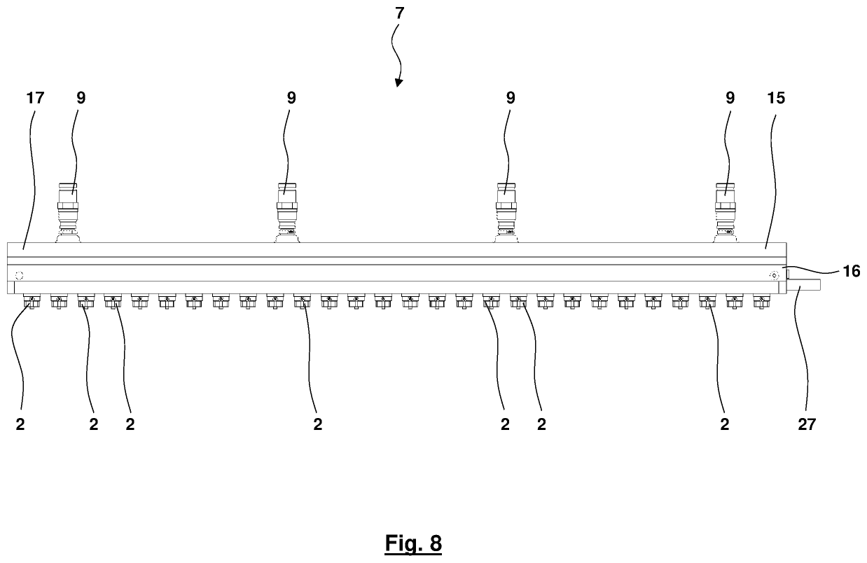

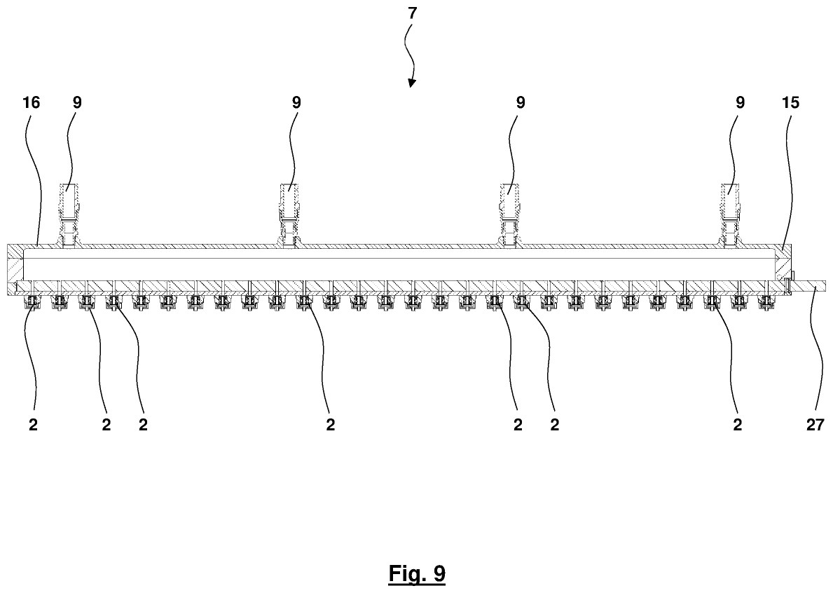

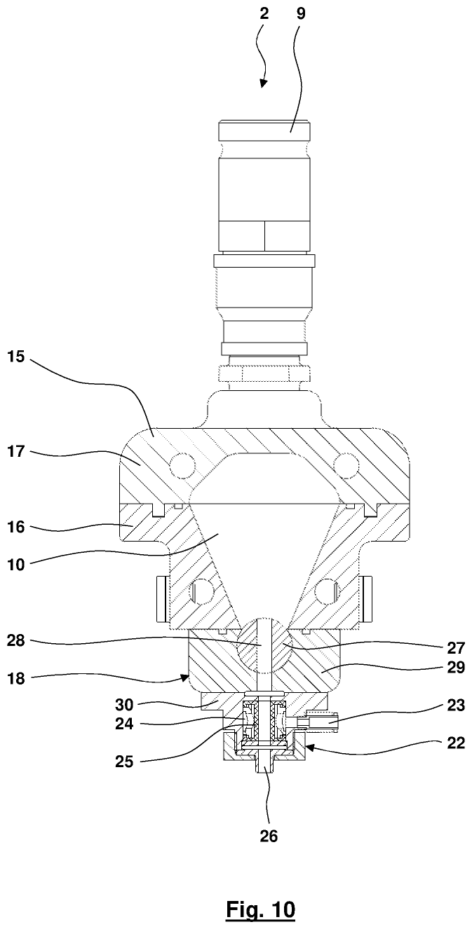

FIGS. 7 to 10 illustrate corresponding views of a second exemplary embodiment of the new apparatus 1, the dosing beam 7 and the confectionery mass dosing units 2. Concerning corresponding features, it is referred to the above-described embodiments to avoid unnecessary repetitions.

In contrast to the drive e.g. including the coupling rod 19, the apparatus 1 here includes a valve shaft 27 via which the locking valves 18 are commonly opened and closed.

Many variations and modifications may be made to the preferred embodiments of the invention without departing substantially from the spirit and principles of the invention. All such modifications and variations are intended to be included herein within the scope of the present invention, as defined by the following claims.

We claim:

1. A confectionery mass dosing unit, comprising:
an outlet opening for dispensing a dosing quantity of confectionery mass from the confectionery mass dosing unit;
a dosing valve for adjusting the dosing quantity, the dosing valve being subjected to pressure; and
an additional locking valve for alternate opening and closing, the locking valve being designed and arranged such that no confectionery mass exits from the outlet opening when the locking valve is closed.

2. The confectionery mass dosing unit of claim 1, wherein the dosing valve is a hose squeeze valve.

3. The confectionery mass of claim 1, wherein the dosing valve is designed to be continuously controllable.

4. The confectionery mass dosing unit of claim 1, wherein the dosing valve is designed to be manually or automatically controllable during operation of the confectionery mass dosing unit.

5. The confectionery mass dosing unit of claim 1, wherein the locking valve is a mechanically actuated valve.

6. The confectionery mass dosing unit of claim 5, wherein the locking valve is a rotary piston valve, a slide valve or a seat valve.

7. The confectionery mass dosing unit of claim 1, wherein the locking valve is designed and arranged to be opened and closed in cycles.

8. An apparatus for dosing a confectionery mass, comprising:
a plurality of confectionery mass dosing units being arranged side-by-side, each of the mass dosing units including:
an outlet opening for dispensing a dosing quantity of confectionery mass from the confectionery mass dosing unit;
a dosing valve for adjusting the dosing quantity, the dosing valve being subjected to pressure; and
an additional locking valve for alternate opening and closing, the locking valve being designed and arranged such that no confectionery mass exits from the outlet opening when the locking valve is closed.

9. The apparatus of claim 8, wherein the locking valves of the confectionery mass dosing units are designed such that they are commonly opened and closed.

10. The apparatus of claim 8, wherein the locking valves of the confectionery mass dosing units are designed such that they can be opened and closed independently from one another.

11. The apparatus of claim 10, further comprising:
an error detection apparatus, the error detection apparatus being designed such that it issues an error signal when there is an error being associated with a locking valve of one of the confectionery mass dosing units; and
a control unit, the control unit being designed and arranged such that the locking valve being associated with the error is closed due to the error signal.

12. The apparatus of claim 8, further comprising a control unit for the dosing valves of the confectionery mass dosing units, the control unit and the dosing valves being designed such that the dosing valves are controllable independently from one another.

13. The apparatus of claim 8, further comprising:
a control unit for the dosing valves of the confectionery mass dosing unit; and
an error detection apparatus,
the control unit and the dosing valves being designed such that the dosing valves are controllable independently from one another,
the locking valves of the confectionery mass dosing units being designed such that they are commonly opened and closed, and
the error detection apparatus being designed such that it issues an error signal when there is an error and the dosing valve being associated with the error is fully closed.

14. The apparatus of claim 8, further comprising:
a control unit for the dosing valves of the confectionery mass dosing unit,
the control unit and the dosing valves being designed such that the dosing valves are controllable independently from one another,
the locking valves of the confectionery mass dosing units being designed such that they are commonly opened and closed, and
the control unit being designed such that, when the locking valves are opened and the dosing valve of a first confectionery mass dosing unit is opened and the dosing valve of an adjacent second confectionery mass dosing unit is closed, the dosing valve of the first confectionery mass dosing unit is further closed.

15. The apparatus of claim 8, further comprising:
a control unit for the dosing valves of the confectionery mass dosing unit,
the control unit and the dosing valves being designed such that the dosing valves are controllable independently from one another,
the locking valves of the confectionery mass dosing units being designed such that they can be opened and closed independently from one another, and
the control unit being designed such that, when the locking valve of a first confectionery mass dosing unit is opened and the locking valve of an adjacent second confectionery mass dosing unit is closed, the dosing valve of the first confectionery mass dosing unit is further closed.
